(19) United States
(12) Patent Application Publication
(10) Pub. No.: US 2014/0378096 A1
(43) Pub. Date: Dec. 25, 2014

(54) UNESTABLISHED COMMUNICATION LINKS IN COMMUNICATION SYSTEMS

(71) Applicant: Subrata Mukherjee, Shanghai (CN)

(72) Inventor: Subrata Mukherjee, Shanghai (CN)

(73) Assignee: Optis Wireless Technology, LLC, Piano, TX (US)

(21) Appl. No.: 14/369,123

(22) PCT Filed: Dec. 28, 2011
(86) PCT No.: PCT/EP2011/074156

§ 371 Date: Jun. 26, 2014

(51) Int. Cl. H04M 3/436; H04W 76/02; H04W 12/12

(52) U.S. Cl. CPC H04M 3/436; H04W 12/12; H04W 76/027
USPC 455/410; 455/560

(57) ABSTRACT

A switching entity in a communication system, configured to obtain characteristics of a terminal submitting a request to establish a communication link in the communication system and to start to establish the communication link while preventing a feed-back signal from reaching the terminal based on the obtained characteristics.

### TECHNICAL FIELD

The present invention relates to a switching entity in a communication system, a network entity in a communication system, and methods, computer programs, and computer program products for operating such entities. More specifically, the present invention relates to preventing a feedback signal to reach a terminal which submits a request to establish a communication link in a communication system.

### BACKGROUND

Communication systems provide services to a plurality of terminals to enable the terminals to communicate with each other. Especially, a communication link can be established between different terminals in order to exchange information in form of audio signals, text messages, images, videos, data or a mixture thereof. One example of the communication link is a call connection. When a call connection is established between terminals, users associated with these terminals can talk to each other.

In communication systems which support establishing call connections, each terminal has an associated switching center. Examples of such communication systems are cellular networks or a public switched telephone network (PSTN). cellular networks may work according to the global system for mobile communications (GSM) or long term evolution (LTE). If two terminals as endpoints of a call connection are associated to one switching center, this sole switching center handles (and switches) the connection.

The establishing of a call connection is usually initiated by a user of a calling terminal dialing a called terminal's telephone number. The calling terminal sends some sort of request (setup message) to its switching center (calling switching center). The setup message may contain the dialed telephone number and other information needed to setup the call and establish a call connection as a communication link in a communication system (see, for example, the 3GPP technical specification “TS 24.008”).

Then, the calling switching center identifies a switching center (called switching center) associated with the called terminal based on the called telephone number. Further, the calling switching center sends a message to the called switching center to inform the called switching center of the request to establish a call connection. This message is, for example, an initial address message containing the calling terminal telephone number and the called terminal telephone number.

The called switching center contacts the called terminal to check whether the called terminal is available to establish a call connection. If the called terminal is available, the called terminal alerts an associated user using audio, visual, or tactile signals. Again, if the two terminals, the calling terminal and the called terminal, are associated to one switching center, one sole switching center takes the roles of the calling switching center and called switching center.

When the called terminal alerts a user, the called switching center sends a signal to the calling switching center indicating that it has received the called telephone number and that the called terminal is alerting. This signal may comprise an address complete message. Further, this signal may comprise an audible ringing tone (ringback tone). Upon receiving the indication that the called terminal is alerting, the calling switching center informs the calling terminal that the called terminal is alerting. This may be done using an alerting message (see, for example, the 3GPP technical specification “TS 24.008”). In turn, the calling terminal informs its user that the called terminal is alerting. This is usually done by presenting a ringback tone and a visual signal on a display of the calling terminal to the user.

The user may take from hearing the ringback tone that the call connection as a communication link is being established. The called switching entity sends the above signal as some sort of feedback signal that is supposed to notify the calling switching entity, the calling terminal, and/or the user of the calling terminal that the call connection being established.

Once the called terminal answers, the communication link—or in the case of telephony: the call connection—is established. Specifically, when the user of the called terminal answers, the called switching center sends an answer message to the calling switching center. Then, the call connection enters the conversation phase, and the user of the calling terminal and the user of the called terminal can talk to each other. Normally, charging starts at this moment.

However, there exists a problem when the establishing of communication links is aborted prior to the link being established. In the case of telephony, this case may correspond to the calling terminal sending a request to establish a call communication with the called terminal, the called terminal alerting the user, but before the called user answers the call, the calling terminal aborts the call (establishing of communication link). Although no link was established, network resources have been deployed. Usually, charging the calling party commences only when the called party answers and the call communication or communication link is established.

Moreover, in recent years, this has led to misuse of communication systems, particularly systems handling telephony service such as cellular, mobile or fixed line communications networks: The called party is alerted, but before the call connection is established and the calling party can be charged, the call is aborted.

The called party then often calls back without taking into consideration the cost involved. If the calling party transmits a telephone number of a so-called premium service (telephone numbers with increased calling charges), the called party runs the risk of being charged with unwanted premium fees.

As far as such miss calls, i.e. aborting the establishing of a communication link prior to the link being established, is concerned, a calling terminal lets a call reach the alerting stage, i.e. to the point that the called terminal is alerting. Then after one or more rings and before the called terminal answers, the calling terminal hangs up and disconnects the call. This type of call is called a miss call or a 1-ring call (even though the call can last for 2, 3, or more rings). In general terms, this corresponds to an unestablished communication link, since establishing was started by request but aborted prematurely.

Unestablished communication links may thus not only waste valuable network and radio resources of the operator without any benefit to the operator, i.e. the operator cannot charge the calling user, but may also used for fraudulent incentives for users to call high-priced telephone numbers or to request premium communication services.

Accordingly there is a need for improvements in communication systems that avoid the waste of resources and makes fraudulent misuse and misuse in general more difficult.

### SUMMARY

It is thus an object of the present invention to save network and radio resources by discouraging miss calls and by reducing the number of unestablished communication links. In particular, it is an object of the present invention to provide a respective switching entity, network entity, methods of operating the same, computer programs, and respective computer program products.

The above objects are accomplished by the subject-matter of the independent claims. Advantageous embodiments are described in the dependent claims.

According to an embodiment of the present invention, there is provided a switching entity in a communication system, configured to obtain characteristics of a terminal submitting a request to establish a communication link in the communication system; and start to establish the communication link while preventing a feedback signal from reaching the terminal based on the obtained characteristics.

According to another embodiment of the present invention, there is provided a network entity in a communication system, configured to collect, for each of a plurality of terminals in the communication system, records comprising information on an unestablished communication link; identify a terminal among the plurality of terminals based on the collected records; and provide characteristics of the identified terminal to the communication system.

According to another embodiment of the present invention, there is provided a method of operating a switching entity in a communication system, comprising the steps obtaining characteristics of a terminal submitting a request to establish a communication link in the communication system; starting to establish the communication link; and preventing a feedback signal from reaching the terminal based on the obtained characteristics

According to another embodiment of the present invention, there is provided a method of operating a network entity in a communication system, comprising the steps collecting, for each of a plurality of terminals in the communication system, records comprising information on an unestablished communication link; identifying a terminal among the plurality of terminals based on the collected records; and providing characteristics of the identified terminal to the communication system.

According to another embodiment of the present invention, there is provided a communication system comprising a switching entity and a network entity according to respective embodiments of the present invention.

According to another embodiment of the present invention, there is provided a computer program loadable onto a processing unit of a switching entity or of a network entity comprising code for executing method embodiments of the present invention, and corresponding computer program products comprising such computer programs.

### BRIEF DESCRIPTION OF THE DRAWINGS

Embodiments of the present invention, which are presented for better understanding the inventive concept but which are not to be seen as limiting the invention, will now be described with reference to the Figures, in which:

FIG. 1 shows a schematic representation of a switching entity according to an embodiment of the present invention;

FIG. 2 shows a schematic representation of a communication network according to an embodiment of the present invention

FIG. 3 snows a schematic representation of a communication network according to an embodiment of the present invention

FIG. 4A shows a schematic representation of a switching entity according to an embodiment of the present invention;

FIG. 4B shows a schematic representation of a network entity according to an embodiment of the present invention;

FIG. 5 shows a flowchart of a method embodiment of the present invention; and

FIG. 6 shows a flowchart of another method embodiment of the present invention;

### DETAILED DESCRIPTION

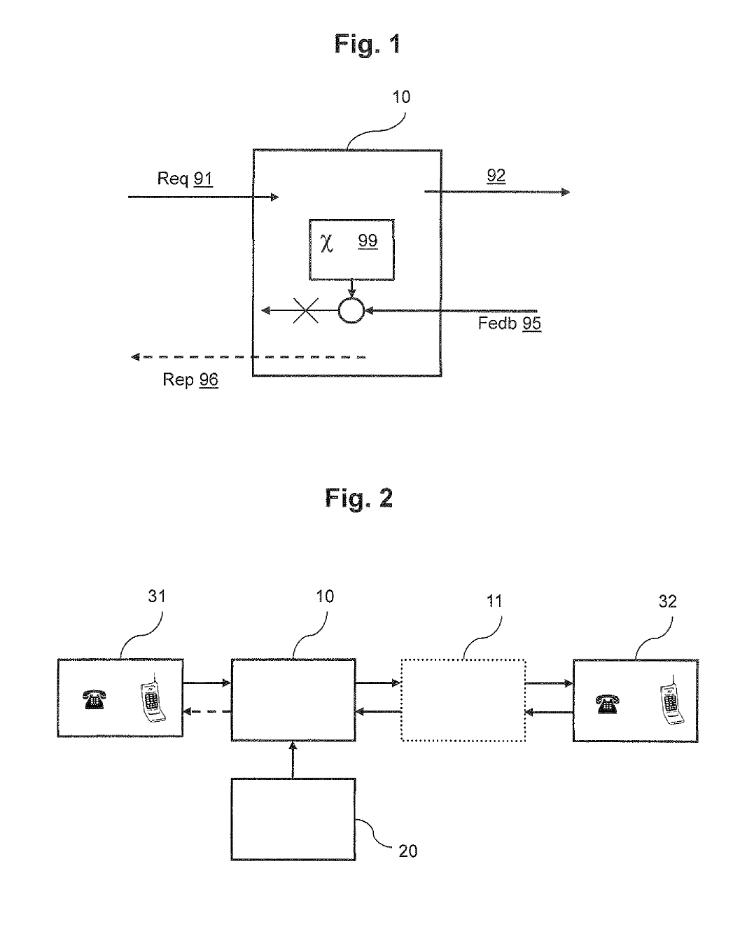

With reference to FIG. 1, a switching entity 10 in a communication system according to an embodiment of the present invention is described. The communication system may be, for example, a public switched telephone network (PSTN) or a cellular network. In case the communication system is a PSTN, the switching entity 10 may be a switching center. In case the communication system is a cellular network, the switching entity 10 may be a mobile switching center(MSC).

The switching entity 10 receives a request 91 to establish a communication link from a terminal using the communication system. The communication link may be a telephony call, a voice over IP (VoIP) call, a data connection etc. A terminal may be a phone, a mobile phone, a fixed line phone, a notebook computer, a personal computer (PC), a smartphone, a personal digital assistant (PDA), a tablet computer, and the like. The terminal which submits the request to establish a communication link will be denoted a calling terminal. A terminal to which the communication link is to be established will be referred to as a called terminal.

Based on the identifier, the switching entity 10 determines a switching entity (called switching entity) associated with the called terminal. For example, in a cellular network, the switching entity 10 can contact a home location register (HLR) to obtain information on the called switching entity. Further, the switching entity 10 sends a message 92 to the called, switching entity to inform the called switching entity about the request to establish a communication link.

In response to the message 92, the switching entity 10 receives a feedback signal 95 indicating a processing state of the establishing of the communication link. The feedback signal 95, for instance, indicates a progress of the establishing and that the called terminal is available and/or ready to establish a communication link to the calling terminal. The feedback signal 95 may also indicate that the called terminal is alerting, i.e. that the called terminal alerts a user of an incoming call by means of acoustic, optic, tactile, vibrational, etc. signals.

Further, the switching entity 10 obtains characteristics 99 of the calling terminal. The characteristics may be obtained before or during the establishing of the communication link. The switching entity 10 judges whether the calling terminal misuses the resources of the communication system based on the characteristics. For example, the characteristics may comprise an indicator indentifying the calling, terminal as a misusing terminal.

If the obtained characteristics indicate that the calling terminal misuses the resources of the network, the feedback signal is prevented from reaching the calling terminal. By preventing the feedback signal from reaching the calling terminal, the calling terminal does not obtain information on the status of the communication link establishing.

Preventing may mean blocking a received signal such that the signal is not relayed to the calling terminal. However, in case the feedback signal would be generated by the switching entity 10, preventing may also mean that the feedback signal is not generated. This is the case, when the terminal tries to communicate with another terminal associated with the same switching entity (one switching entity operating as calling switching entity and called switching entity).

Optionally, the switching entity 10 may transmit a replacement signal 96 to the terminal when preventing the feedback signal from reaching the terminal. The replacement signal may be a signal containing a voice message signal, a sound signal, and/or a noise signal. Such signals may indicate that the communication link is being established without conveying to the calling party that the called party is alerting. For example, a voice message signal as a replacement signal 96 may inform the calling party “that the call is being set up” or the like. In this way, the calling party may refrain from aborting the call, since it expects a ringback tone as an indication that the called party is alerted.

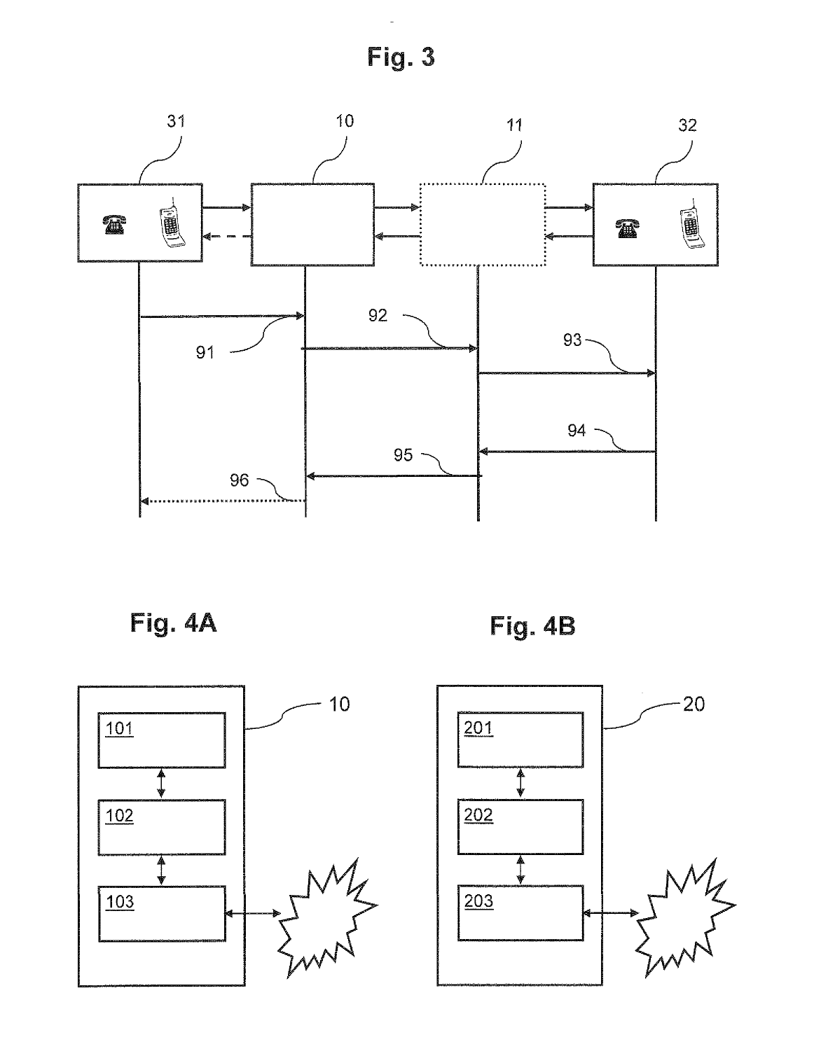

Now with reference to FIGS. 2 and 3, an exemplary scenario is described. More specifically, FIGS. 2 and 3 describe an embodiment of the present invention where a calling terminal 31 tries to establish a call connection (communication link) to a called terminal 32.

The calling terminal 31 transmits a request 91 to establish a call connection to the switching entity 10. The request 91 may include an identifier of the called terminal 32 such as a telephone number. For example, in a cellular network the request may be a call control (CC) setup message containing a mobile station integrated services digital network number (MSISDN) of the called terminal.

Then, the switching entity 10 indentifies the switching entity 11 associated with the called terminal 32. The switching entity 10 may do so by contacting a home location register (HIP) in the communication system that contains information connecting the called terminal with a switching entity 11 serving the called terminal 32.

The switching entity 10 transmits a message 92 to the called switching entity 11 indicating that the calling terminal 31 requests to establish a call connection to the called terminal 32. This message 92 is, for example, an initial address message containing the calling terminal telephone number and the called terminal telephone number. When receiving the message 92, the called switching entity 11 contacts via message 93 the called terminal 32.

The called terminal 32 alerts an associated user. The alerting may be done using audio, visual or tactile signals. In addition, the called terminal 32 informs via message 94 the called switching entity 11 about the alerting. In turn, the called switching entity 11 transmits a message 95 to the switching entity 10 indicating that the called terminal 32 is alerting. For example, this message 95 may be a CC alerting message or ACM address complete message. In addition, the called switching entity 11 may transmit 95 an audible ringing tone (ringback tone, feedback signal) to the switching entity 10.

When the switching entity 10 receives the indication 95 that the called terminal 32 is alerting, the switching entity 10 checks whether the calling terminal 31 is identified as a misusing terminal based on characteristics 99 of the calling terminal 31. These characteristics may be provided by a network entity 20 and may comprise a parameter indicating that the calling terminal 31 misuses the resources of the communication system. For example, characteristics may be retrieved from the HLR of the communication system, and information indicating that no ringback tone is to be provided to the calling terminal 31 is included in the calling terminal's subscription information in HLR.

The characteristics may be obtained before or during the call connection establishing. For example, the characteristics are transferred from the HLR to a visitor location register (VLR) of the switching entity 10 during a location update in a ‘insert subscriber data’ mobile application part (MAP) message.

If the switching entity 10 identifies the calling terminal 31 as a misusing terminal, the ringback tone and/or feedback signal is prevented from reaching the calling terminal 31. For example, the switching entity 10 controls the group switch in the media gateway for server architecture so that the group switch prevents the ringback tone generated by the called switching entity 11 from reaching the calling party. Hence, the switching entity 10 blocks the ringback tone.

Therefore, once a terminal has been indentified as misusing the communication system using miss calls, no ringback tones are provided to the terminal for all calls. Thus, when the terminal makes a call, the called terminal will ring, but a user of calling terminal will not hear the ringback tone and will not be sure if the call has reached the intended destination and wait until the called party answers. This would force the caller to pay for the call.

In case the called terminal 32 is served by the same switching entity 10 as the calling terminal 31, preventing the feedback signal from reaching terminal 31 may simply imply that any ringback tone is not generated. Furthermore, the switching entity 10 can send a replacement signal 96 to the calling terminal 31, when the ringback tone or feedback signal is prevented from reaching the calling terminal 31.

Now the processing leading to the identification of a terminal as misusing the resources of the communication system will be described. This processing is performed by the network entity 20.

The network entity 20 collects records comprising information on unestablished communication links. If the communication link is a call connection, the records may be a call data record (CDR). CDRs are generated for charging purposes. Among other information, the following information is available in a CDR:
Calling/Called terminal information (international mobile subscriber identity (IMSI), MSISDN);
Call Position, i.e. if the call reached the alerting stage or not, or if the call reached the stage where the called terminal answered;
Period of time the called terminal alerted;
Which, terminal disconnected the call;
Reason for call disconnection.

In one embodiment of the present invention, a Mobile Originating (MO) CDR is produced in the calling switching center for the call leg associated with the calling terminal.

Like other CDRs, the MO CDR can be produced for all calls or for calls that reach alerting stage or only for calls that the called terminal has answered. In some switching centers, this is an configurable option. In order to be able to determine that a call is a miss call, switching centers have to be configured to produce CDRs for either all calls or for calls that reach alerting stage, i.e. switching centers cannot be configured to produce CDRs only for calls that reach answer stage.

The network entity 20 judges for every collected record whether the record is associated with a miss call (as an example, miss calls can be identified by product “ENIQ” by Ericsson). The judgment may be based on various criteria.

For example, a call attempt is classified as a miss call
if the unestablished call connection only reached the alerting stage and the call was disconnected for a normal reason;
if the unestablished call connection only reached the alerting stage, the calling terminal disconnected the call and the call was disconnected for a normal reason;
if the unestablished call connection only reached the alerting stage, the calling terminal disconnected the call and the called terminal alerted for a period of time below a predetermined value.

The network entity 20 may identify a terminal as a misusing terminal when the total number of miss calls exceeds a predetermined threshold, e.g. if the total number of miss calls exceeds 5 five per day.

The network entity 20 may also indentify a terminal as misusing the communication system, if a ratio of the number of miss calls and the total number of unestablished call connections exceeds a predetermined threshold. Examples are shown in the table below:

| | Number | Number | % of |
|---|---|---|---|
| | of call | of ‘miss | miss |
| | attempts | calls’ in | calls in |
| Subscriber | in last | last 48 | last 48 |
| Number | 48 hours | hours | hours |
| 123456789 | 22 | 18 | 82 |
| 213456789 | 18 | 13 | 72 |
| 312456789 | 36 | 24 | 67 |

If the percentage of miss calls increases above a certain level, e.g. 50%, the respective terminal is identified a misusing terminal.

In general, it may also be determined, for each of a plurality of terminals, a first number of unestablished communication links based on information on unestablished communication links indicating that the terminal aborted the establishing of the communication link within a predetermined time after submitting the request. The first number may thus represent a number of calls that have been aborted shortly after requesting their respective establishing and set up.

Further, it may be determined, again for each of the plurality of terminals, a total number of unestablished communication links regardless of the time the terminal aborted the establishing of the communication link after submitting the request. The total number includes therefore all unsuccessful call requests, i.e. also calls which have not been answered by the called party even after alerting the party for considerable time, calls that have been aborted by the system (e.g. due to breakage of a radio link), and also calls that have been explicitly rejected by the called party.

Therefore, the misusing terminal can be identified by comparing a ratio of the first number and the total number to a predetermined threshold. E.g. the terminal is identified as misusing if the ratio exceeds the predetermined threshold.

When a misusing terminal is identified, characteristics of the terminal are provided to the communication system. For instance, this may be done by setting a parameter in the HLR. Alternatively, the characteristics may be transmitted directly to the switching entity 10.

The network entity 20 may be comprised by the switching entity 10 or generally the functions of the switching entity and the network entity may be an integrated functionality of one entity such as a processing unit of communication system, a network node, a program running on one or more distributed processing units and the like.

As shown in FIG. 4A, for performing the above processing and the below described method, the switching entity 10 may comprise a processing unit 102, a memory unit 101 coupled to the processing unit 102, and a communication unit 103 coupled to the processing unit 102. The memory unit 101 is configured to store characteristics of terminals. The communication unit 103 is configured to communicate with the communication system. Further, in the memory unit 101 there may be stored a computer program loadable into the processing unit 102 comprising code for executing the steps of the described method embodiments of operating a switching entity. This method may be adapted to another disclosed embodiment.

FIG. 4B shows a schematic representation of a network entity 20 according to the present invention. The network entity may comprise a processing unit 202, a memory unit 201 coupled to the processing unit 202, and a communication unit 203 coupled to the processing unit 202. The communication unit 203 is configured to communicate with the communication system and to receive records comprising information on an unestablished communication link. The memory unit 201 may comprise code to instruct the processing unit 202 to identify terminals misusing the resources of the network based on the collected records. Further, in the memory unit 201 there may be stored a computer program loadable into the processing unit 202 comprising code for executing the steps of the described method embodiments of operating a network entity. This method may be adapted to another disclosed embodiment.

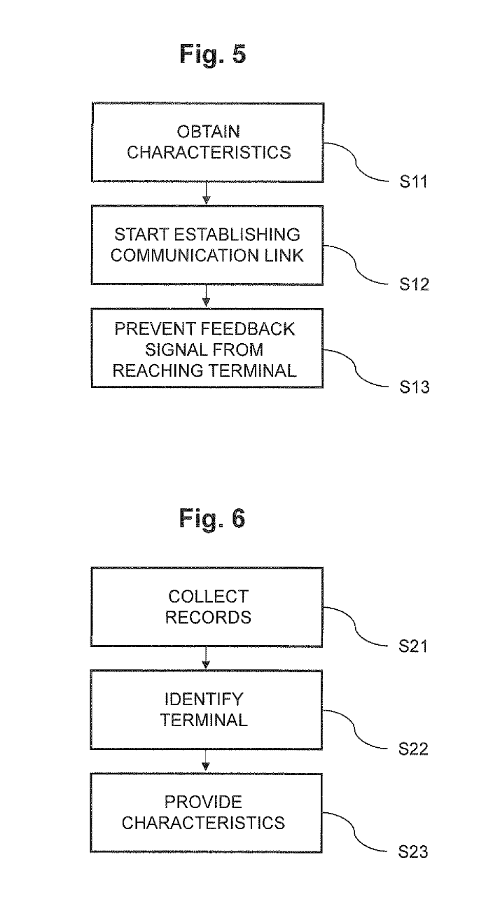

FIG. 5 shows a flowchart of a method embodiment for operating a switching entity. The method may be for operating a switching entity as described in conjunction with the above embodiments. The method comprises the step S11 of obtaining characteristics of a terminal submitting a request to establish a communication link in the communication system; the step S21 of starting to establish the communication link; and the step S13 of preventing a feedback signal from reaching the terminal based on the obtained characteristics.

FIG. 6 shows a flowchart of a method of operating a network entity. The method may be for operating a network entity as described above in conjunction with FIG. 4B. The method comprises the step 21 of collecting, for each of a plurality of terminals in the communication system, records comprising information on an unestablished communication link; the step S22 of identifying a terminal among the plurality of terminals based on the collected records; and the step S23 of providing characteristics of the identified terminal to the communication system.

Embodiments of the present invention may provide one or more of the following advantages. The operator of a communication system is enabled to identify users of the system which misuse the resources of the communication system via miss calls. Further, the present invention increases the possibility of miss calls being answered and thus being charged.

Although detailed embodiments have been described, these only serve to provide a better understanding of the invention defined by the appended claims, and are not to be seen as limiting.

1. A switching entity in a communication system, configured to:
obtain characteristics of a terminal submitting a request to establish a communication link in the communication system; and
start to establish the communication link while preventing a feedback signal from reaching the terminal based on the obtained characteristics.

2. The switching entity according to claim 1, wherein the communication link is a call connection between the terminal submitting the request and a called terminal.

3. The switching entity according to claim 2, wherein the feedback signal indicates that the called terminal is alerting a terminal user.

4. The switching entity according to claim 1, wherein the feedback signal indicates a processing state of the establishing of the communication link.

5. The switching entity according to claim 1, wherein the obtained characteristics comprise information indicating that the terminal has previously aborted the establishing of the communication link after submitting the request and prior to the communication link being established.

6. The switching entity according to claim 1, further configured to send a replacement signal to the terminal when preventing the feedback signal from reaching the terminal.

7. The switching entity according to claim 6, wherein the replacement signal contains any one of a voice message signal, a sound signal, and a noise signal.

8. The switching entity according to claim 1, wherein the switching entity is a mobile switching center in a cellular communication network.

9. A network entity in a communication system, configured to:
collect, for each of a plurality of terminals in the communication system, records comprising information on an unestablished communication link;
identify a terminal among the plurality of terminals based on the collected records; and
provide characteristics of the identified terminal to the communication system.

10. The network entity according to claim 9, wherein the communication link is a call connection between the terminal and a called terminal.

11. The network entity according to claim 9, wherein the terminal is identified based on information on an unestablished communication link comprised by the collected records.

12. The network entity according to claim 11, wherein the information on the unestablished communication link indicates that the terminal aborted the establishing of the communication link after submitting a request to establish the communication link and prior to the communication link being established.

13. The network entity according to claim 11, wherein the terminal is identified if the number of unestablished communication links exceeds a predetermined threshold.

14. The network entity according to claim 11, wherein the information on the unestablished communication link indicates that the terminal aborted the establishing of the communication link within a predetermined time after submitting the request.

15. The network entity according to claim 12, further configured to:
determine, for each of the plurality of terminals, a first number of unestablished communication links based on information on unestablished communication links indicating that the terminal aborted the establishing of the communication link within a predetermined time after submitting the request;
determine, for each of the plurality of terminals, a total number of unestablished communication links regardless of the time the terminal aborted the establishing of the communication link after submitting the request; and to
identify the terminal if a ratio of the first number and the total number exceeds a predetermined threshold.

16. The network entity according to claim 9, wherein the communication system is a cellular network.

17. (canceled)

18. A method of operating a switching entity in a communication system, comprising the steps:
obtaining characteristics of a terminal submitting a request to establish a communication link in the communication system;
starting to establish the communication link; and
preventing a feedback signal from reaching the terminal based on the obtained characteristics.

19. The method according to claim 18, adapted to operate a switching entity according to claim 2.

20. (canceled)

21. A method of operating a network entity in a communication system, comprising the steps:
collecting, for each of a plurality of terminals in the communication system, records comprising information on an unestablished communication link;
identifying a terminal among the plurality of terminals based on the collected records; and
providing characteristics of the identified terminal to the communication system.

22. The method according to claim 21, adapted to operate a network entity according to claim 10.

23. (canceled)

24. (canceled)
